(19) United States
(12) Patent Application Publication
(10) Pub. No.: US 2005/0171637 A1
(43) Pub. Date: Aug. 4, 2005

(54) Self-running cleaner with collision obviation capability

(75) Inventors: Takao Tani, Osaka (JP); Ryo Saeki, Daito-shi (JP)

Correspondence Address: OSHA LIANG L.L.P., 1221 MCKINNEY STREET, SUITE 2800, HOUSTON, TX, 77010, US

(73) Assignee: Funai Electric Co., Ltd., Osaka (JP)

(21) Appl. No.: 11/045,186

(22) Filed: Jan. 28, 2005

(30) Foreign Application Priority Data
Jan. 30, 2004 (JP) JP2004-024050

(51) Int. Cl. G06F 19/00

(52) U.S. Cl. 700/245; 701/23

(57) ABSTRACT

A main body of a self-running cleaner conducts a cleaning job while self-propelling at a velocity vector in the direction of the arrow. A person approaches with a movement vector in the direction of the arrow in front of the main body. A determination processing unit of the main body rotates the main body such that the velocity vector of the main body is orthogonal to the movement vector of the person when determination is made of the possibility of collision between the obstacle and the main body from a calculated result (rotation A). Then, the main body is moved straight ahead a predetermined distance in the direction of travel after the rotation. When the person continues to move during the withdrawal operation of the main body, and determination is made that there is no possibility of collision therebetween, the determination processing unit rotates the main body 180° (rotation B), and moves the main body straight ahead the predetermined distance, such that the main body returns to the former position immediately previous to the obviation operation. The main body is rotated such that the velocity vector of the main body corresponds to the direction of travel immediately previous to the sensing of a person (rotation C), and the cleaning job is resumed.

### BACKGROUND OF THE INVENTION

1. Field of the Invention

The present invention relates to self-running cleaners, and more particularly to a self-running cleaner executing a cleaning job while avoiding collision with a moving obstacle.

2. Description of the Background Art

Recently, self-running cleaners have been developed, equipped with travel steering means and travel control means to conduct cleaning automatically in a cordless manner through a loaded secondary battery (for example, refer to Japanese Patent Laying-Open Nos. 8-275913 and 2003-61882).

FIG. 6 is a side view of a conventional self-running cleaner disclosed in Japanese Patent Laying-Open No. 8-275913.

Referring to FIG. 6, the self-running cleaner includes, as cleaning means, a suction nozzle 33 at the bottom of a main body 30, a dust chamber 34, and a fan motor 35. The self-running cleaner also includes, for migration, a driving wheel 32 and trailing wheel 31 identified as travel steering means, an obstacle sensing means 36 for sensing an obstacle during travel, and a gyro sensor 38 identified as position identify means for identifying the position.

The self-running cleaner has the distance to the peripheral wall of the cleaning site measured through obstacle sensing means 36, and then identifies the cleaning area by gyro sensor 38 while moving along in accordance with the measured distance to the wall to clean the entire area based on autonomous travel.

When the self-running cleaner stops, the distance from an obstacle is measured through obstacle sensing means 36. The moving speed of the cleaner is reduced in accordance with the measured distance. Main body 30 stops when the distance from the obstacle attains a predetermined stop preset distance. Accordingly, main body 30 can be stopped safely with respect to a stationary obstacle such as the wall.

In the case where a moving obstacle such as a person crosses the pathway of main body 30, there is a possibility of main body 30 colliding with the obstacle since main body 30 cannot stop upon ensuring a safe distance from the obstacle.

In view of the foregoing, a conventional self-running cleaner includes a sensed status determination means 37 for determining as to whether an obstacle is stationary or moving from the sensed status by obstacle sensing means 36, and a determination processing means 39 to move sideways from the obstacle in accordance with a signal from sensed state determination means 37 while moving back and forth so as to maintain a predetermined distance from the obstacle.

Specifically, sensed state determination means 37 monitors the distance from the obstacle sensed by obstacle sensing means 36, and notifies determination processing means 36 of a great change in distance. Determination processing means 39 determines that a moving obstacle has been sensed from a signal from sensed state determination means 37, and controls travel steering means 31 and 32 as well as cleaning means 33, 34 and 35 to alter the deceleration action termination site to stop main body 30 safely. By such a configuration, main body 30 can always be stopped safely independent of the (stationary/moving) state of an obstacle in a conventional self-running cleaner.

Thus, a conventional self-running cleaner is adapted to stop the main body safely by determining the deceleration action termination site based on the sensed state of the obstacle.

However, avoiding collision with an obstacle by stopping the main body is not desirable since the cleaning job will be interrupted at each stop, leading to degradation of the job efficiency.

Japanese Patent Laying-Open No. 2003-61882 discloses a self-running cleaner addressing the problem of collision with an obstacle by measuring the distance from the obstacle through obstacle sensing means to avoid collision while proceeding with the cleaning job. It is possible to continue the cleaning job while avoiding collision with an obstacle by the obstacle sensing means if the obstacle is stationary. However, if the obstacle is moving, the distance between the main body and the obstacle may suddenly change so that the obviation operation will not be executed properly, leading to the possibility of colliding with the obstacle. Furthermore, the obviation operation will cause the main body to deviate from the former course. It will therefore be difficult to conduct a cleaning job efficiently.

### SUMMARY OF THE INVENTION

In view of the foregoing, an object of the present invention is to provide a self-running cleaner that can detect possibility of collision with an obstacle to prevent such collision, and that can carry out a cleaning job safely and efficiently.

According to an aspect of the present invention, a self-running cleaner includes a cleaning unit to clean the floor, a travel steering unit for self-propelling of a main body, a position identify unit identifying an azimuth of cleaning of the main body, an obstacle sensing unit sensing presence of an obstacle, and a determination processing unit controlling the cleaning unit and travel steering unit in accordance with an input from the position identify unit and obstacle sensing unit. The obstacle sensing unit senses an obstacle and outputs an activated sensed signal. The determination processing unit includes a moving/stationary determination unit determining whether the obstacle is moving/stationary in response to activation of a sensed signal, and a storage unit storing the azimuth of cleaning at the sensed time point of an obstacle and a moving direction of the obstacle. In response to determination that the obstacle is moving by the moving/stationary determination unit, the travel steering unit rotates and moves the main body straight ahead a predetermined distance to withdraw the main body from the obstacle such that the direction of travel of the main body is orthogonal to the moving direction of the obstacle. In response to inactivation of the sensed signal after the withdrawal, the main body has its direction of travel rotated 180° and moved straight ahead the predetermined distance to return to the former position where the obstacle was sensed, and the cleaning unit and the travel steering unit are driven after the main body has its direction of travel rotated back to the azimuth of cleaning corresponding to the sensed time point.

According to another aspect of the present invention, a self-running cleaner includes a cleaning unit cleaning a floor, a travel steering unit for self-propelling of a main body, a position identify unit identifying an azimuth of cleaning of the main body, an obstacle sensing unit sensing presence of an obstacle, and a determination processing unit controlling the cleaning unit and travel steering unit in accordance with an input from the position identify unit and obstacle sensing unit. The obstacle sensing unit senses an obstacle to output a sensed signal. The determination processing unit includes a moving/stationary determination unit determining as to whether the obstacle is moving/stationary in response to activation of a sensed signal, a withdrawal unit withdrawing the main unit from the obstacle with the direction perpendicular to the moving direction of the obstacle as the direction of travel in response to determination that the obstacle is moving by the moving/stationary determination unit, and a recovery unit responsive to inactivation of the sensed signal after withdraw to return the main body to the former position where an obstacle was sensed, and executing a cleaning job with the azimuth of cleaning corresponding to the sensed time point as the direction of travel.

Preferably, the determination processing unit further includes a storage unit storing an azimuth of cleaning corresponding to the sensed time point of an obstacle and a moving direction of the obstacle.

Further preferably, the obstacle sensing unit responds to activation of the sensed signal to detect twice the position of the obstacle at an interval of a predetermined term to output first and second detection result signals. The moving/stationary determination unit determines whether the obstacle is moving/stationary based on the first and second detection result signals to detect the moving direction of the obstacle.

Preferably, the withdrawal unit has the main body rotated and moved straight ahead a predetermined distance by the travel steering unit such that the direction of travel of the main body is orthogonal to the moving direction of the obstacle. The recovery unit responds to inactivation of the sensed signal to have the direction of travel of the main body rotated 180° and moves the main body straight ahead the predetermined distance to return to the former position where the obstacle was sensed, and drives the cleaning unit and the travel steering unit after the main body has its direction of travel rotated back to the azimuth of cleaning corresponding to the sensed time point.

According to a further aspect of the present invention, a self-running cleaner includes a cleaning unit cleaning a floor, a travel steering unit for self-propelling of a main body, a position identify unit identifying an azimuth of cleaning of the main body, an obstacle sensing unit sensing presence of an obstacle, a determination processing unit controlling the cleaning unit and travel steering unit in accordance with an input from the position identify unit and obstacle sensing unit, and a notify unit indicating the state of the main body by an audio or visual signal. The obstacle sensing unit senses an obstacle to output a sensed signal. The determination processing unit responds to input of the sensed signal to reduce the running speed of the main body through the travel steering unit, and outputs an audio or visual signal towards the obstacle from the notify unit.

In accordance with an aspect of the present invention, collision with an obstacle can be obviated by sensing a moving obstacle and conducting an obviation operation of collision. Since the main body is returned to its former position immediately previous to sensing after the collision obviation operation and resumes the cleaning job, higher job efficiency can be realized.

In accordance with another aspect of the present invention, collision with an obstacle can be avoided, even if a moving obstacle is sensed, without the main body stopping or having to take a detour, allowing continuation of the cleaning job. Therefore, job efficiency can be improved.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIGS. 1A and 1B are a side view and a plan view, respectively, of a self-running cleaner according to a first embodiment of the present invention.

FIG. 2 is a control block diagram of the self-running cleaner of FIGS. 1A and 1B.

FIG. 3 is a schematic diagram to describe the principle of a collision obviation operation at the self-running cleaner of the present embodiment.

FIG. 4 is a flow chart to realize the principle of the collision obviation operation described with reference to FIG. 3.

FIG. 5 is a flow chart to describe a collision obviation operation carried out by a self-running cleaner according to a second embodiment.

FIG. 6 is a side view of a conventional self-running cleaner disclosed in Japanese Patent Laying-Open No. 8-275913.

### DESCRIPTION OF THE PREFERRED EMBODIMENTS

Embodiments of the present invention will be described in detail with reference to the drawings. In the drawings, the same or corresponding components have the same reference characters allotted, and the description thereof will not be repeated.

### First Embodiment

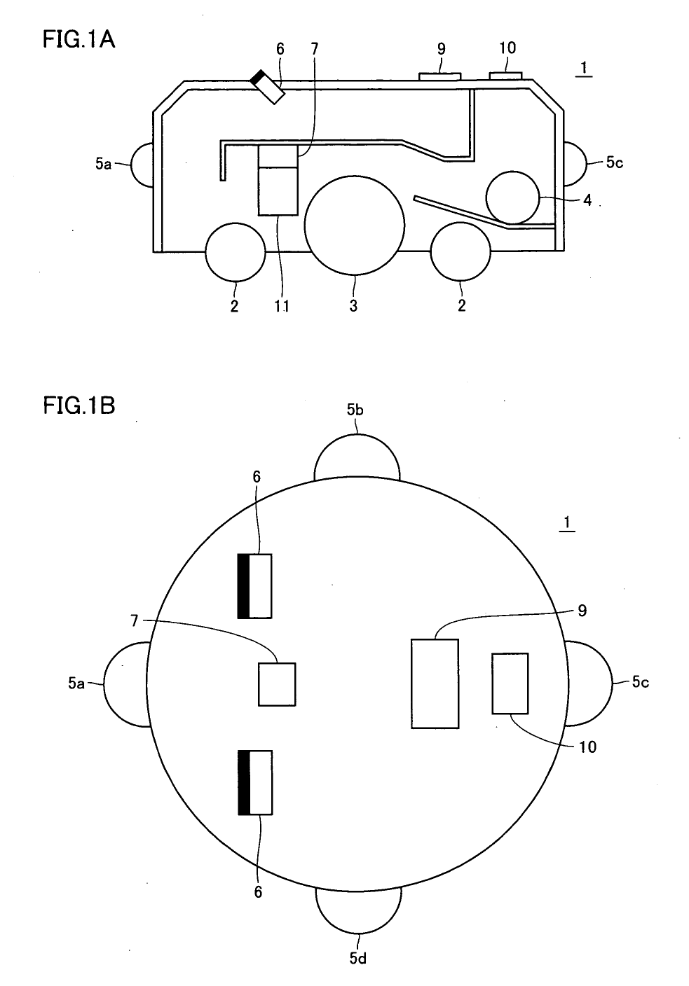

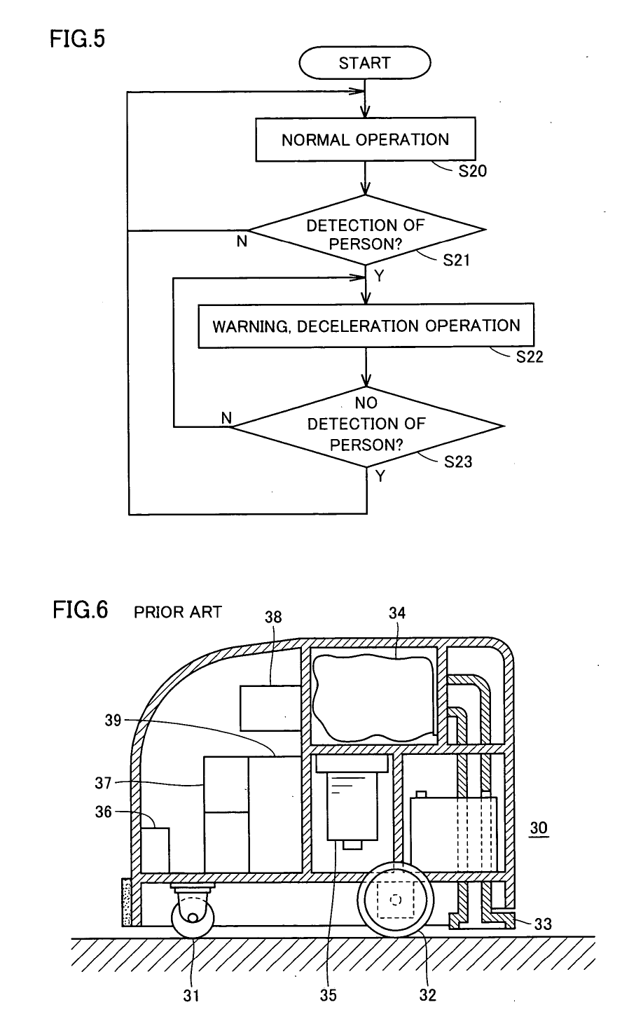

Referring to FIG. 1A, a self-running cleaner according to a first embodiment of the present invention includes a rolling brush 3 and a suction motor 4 as the cleaning unit, and a driving wheel 2 as the travel steering unit. The cleaning unit and the travel steering unit are respectively under control of a determination processing unit 11. The function of respective means is similar to that of the conventional self-running cleaner described above (refer to FIG. 6). Therefore, detailed description thereof will not be repeated.

Determination processing unit 11 covers control of the entire self-running cleaner, and is formed of, for example, a microprocessor (MPU: microprocessor unit).

As shown in FIG. 1B, the self-running cleaner also includes human body sensors 5a-5d and a proximity sensor 6 as an obstacle sensing unit, and a geomagnetic sensor 7 as a position identify unit. Alternatively, a gyrosenser, an acceleration sensor (both not shown) or the like may be used in addition to a geomagnetic sensor as a position identify unit.

Body sensors 5a-5d include a pair of sensors at the front side and back side of main body 1 (sensors 5a, 5c) and a pair of sensors at the left side and right side (sensors 5b, 5d) of main body 1. These four body sensors 5a-5b are formed of, for example, a pyroelectric sensor. A pyroelectric sensor takes advantage of the piezoelectric effect of charge appearing at the crystal surface when a portion of the piezoelectric crystal is heated to detect energy in the proximity of 10 μm in wavelength emitted from the human body. In the configuration of FIG. 1B, each of body sensors 5a-5d senses a human body entering a sensing range of ±45° about the arranged direction. As used herein, human body sensors 5a-5d are generically designated by reference no. 5.

Geomagnetic sensor 7 is a sensor employed in the detection of the terrestrial magnetism to identify the orientation of course of the self-running cleaner (hereinafter, also referred to as “azimuth of cleaning”). In a normal operation, the self-running cleaner runs in a self-propelled manner with a sensed signal from geomagnetic sensor 7 as the position information.

Proximity sensor 6 functions to detect the position of an obstacle when such an obstacle is approaching, and is inclined 45°, for example, upwards from the horizontal plane with respect to the direction of travel of the main body. Proximity sensor 6 senses an obstacle appearing in the course of main body 1 to measure the distance from the obstacle. Proximity sensor 6 is formed of, for example, a pair of passive sensors arranged perpendicular to the direction of travel of main body 1, as shown in FIG. 1B. Each of the passive sensors is formed of a plurality of passive sensor elements (not shown), having a sensing range proportional to the number of the sensor elements. In the present configuration, proximity sensor 6 senses the contrast of an obstacle with a pair of passive sensors to detect the distance from the obstacle based on the displacement of the obstacle's position caused by the parallax (phase difference) of the obstacle projected on each passive sensor.

The self-running cleaner further includes a display panel 9 and a speaker 10 as the notify unit to notify the user the operational state of main body 1 (job start/job end/abnormal event, and the like). By such means, the user can be made aware of the state of main unit 1 even at a remote site to respond quickly at the occurrence of an abnormal event.

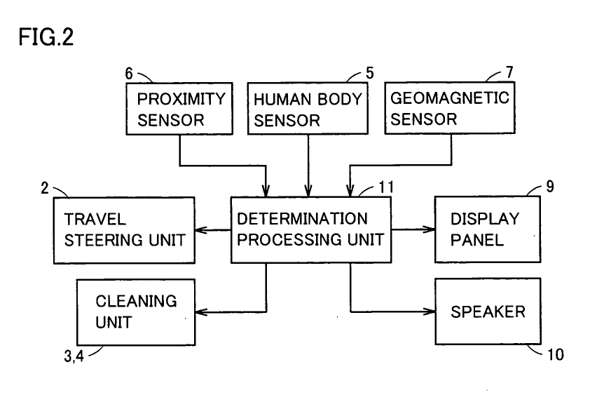

FIG. 2 is a control block diagram of the self-running cleaner of FIGS. 1A and 1B.

Referring to FIG. 2, when determination processing unit 11 receives sensed signals from human body sensor 5, proximity sensor 6 and geomagnetic sensor 7, a control signal in accordance with the contents of respective signal is output to the travel steering unit (driving wheel 2) and the cleaning unit (rolling brush 3, suction motor 4). The travel steering unit responds to the control signal to adjust the running speed/running direction. The cleaning unit responds to the control signal to drive/stop suction motor 4 and rolling brush 3.

Determination processing unit 11 also outputs a control signal to the notify unit formed of display panel 9 and speaker 10. The user is made aware of the state of main body 1 through the display on display panel 9 or the sound output from speaker 10 in accordance with the control signal.

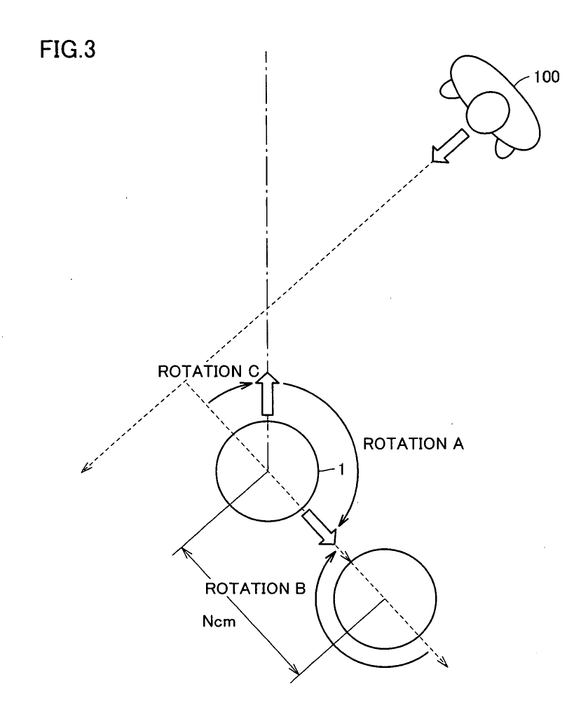

FIG. 3 is a schematic diagram to describe the principle of the collision obviation operation in the self-running cleaner of the present embodiment.

Referring to FIG. 3, main body 1 conducts a cleaning job while running at the velocity vector in the direction indicated by the arrow. It is now assumed that an obstacle (for example, a person) 100 with a movement vector in the direction indicated by the arrow is approaching ahead of the direction of travel of main body 1. If main body 1 and person 100 continue their travel and movement under such circumstances, it is expected that they may collide at the spot where the dashed line crosses the chain dotted line. The possibility of collision can be obtained from a calculation by determination processing unit 11 of main body 1, based on the velocity vector of main body 1, the movement vector of person 100, and the distance therebetween.

When determination is made of the possibility of collision therebetween from the calculated result, determination processing unit 11 rotates main body 1 (corresponding to rotation A in FIG. 3) such that the velocity vector of main body 1 is orthogonal to the movement vector of person 100, as shown in FIG. 3. Then, main body 1 is moved straight forward a predetermined distance of N cm (N is a positive number) in the direction of travel after rotation of main body 1. This predetermined distance is set sufficiently so as to withdraw main body 1 from the course of person 100.

By withdrawing main body 1 in a direction perpendicular to the moving direction of person 100, the possibility of collision between main body 1 and person 100 can be obviated.

In the case where person 100 continues to move in the direction of the arrow on the chain dotted line in FIG. 3 during the withdrawal operation of main body 1 set forth above and determination is made that there is no longer the possibility of collision therebetween, determination processing unit 11 rotates main body 1 180° (corresponding to rotation B in FIG. 3) and moves main body 1 straight ahead a predetermined distance N cm, whereby main body 1 returns to the former position immediately previous to the withdrawal operation. Furthermore, determination processing unit 11 rotates main body 1 (corresponding to rotation C in FIG. 3) such that the velocity vector of main body 1 corresponds to the direction of travel immediately previous to sensing person 100 (corresponding to the azimuth of cleaning). Then, the cleaning job and running operation is initiated again.

In accordance with the self-running cleaner of the present embodiment described above, collision with person 100 is obviated, and the cleaning job interrupted by the obviation operation can be resumed. Safety and high job efficiency of main body 1 are ensured by the present embodiment.

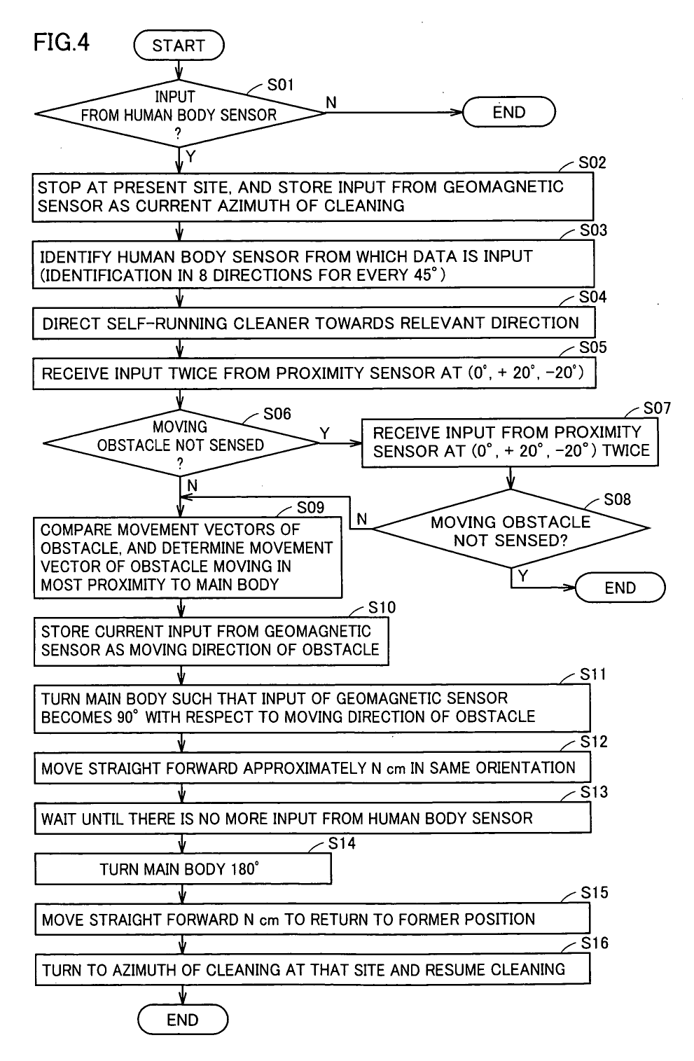

FIG. 4 is a flow chart to realize the principle of the collision obviation operation described with reference to FIG. 3.

Referring to FIG. 4, determination processing unit 11 of main body 1 monitors any input from human body sensors 5a-5d parallel to the normal cleaning job (step S01). When person 100 that is an obstacle is sensed by at least one of the plurality of human body sensors 5a-5d in main body 1, a sensed signal from the relevant human body sensor is applied to determination processing unit 11.

In response to an input of a sensed signal from at least one of human body sensors 5a-5d at step S01, determination processing unit 11 instructs travel steering unit 2 to stop main body 1 at that site. Additionally, the input from geomagnetic sensor 7 at that time point is stored in the storage unit in determination processing unit 11 as the current azimuth of cleaning (step S02).

Then, determination processing unit 11 identifies the relevant human body sensors 5a-5d providing the sensed signal (step S03). The four human body sensors 5a-5d disposed at the front, back, left, and right sides for every 90° of main body 1 senses person 100 in a sensing range of 8 directions for every 45°. For example, an output of a sensed signal from human body sensor 5a in FIG. 1B indicates that person 100 has been sensed in the front direction of main body 1. Respective outputs of sensed signal from human body sensors 5a and 5b implies that person 100 has been sensed in the right oblique direction of 45° from the front of main body 1. Although the present embodiment employs a configuration in which four human body sensors 5a-5d are arranged, the sensing sensitivity can be improved by arranging more human body sensors.

Upon determination of the sensed direction of person 100 at step S03, determination processing unit 11 directs the front of main body 1 in the sensed direction through travel steering unit 2 (step S04).

Furthermore, determination processing unit 11 rotates main body 1 in the range of ±20° about this sensed direction through travel steering unit 2. At this stage, proximity sensor 6 located at the top of main body 1 measures the distance between main body 1 and person 100 in the three directions of (0°, +20°, −20°), and provides the measured results to determination processing unit 11. The outputs in the three directions from proximity sensor 6 are taken as the first sensor output. At an elapse of a predetermined term, proximity sensor 6 outputs again measured results of the distance between main body 1 and person 100 in the three directions of (0°, +20°, −20°). These outputs of the three directions are taken as the second sensor output. Specifically, proximity sensor 6 outputs the detected results in the three directions of (0°, +20°, −20°) twice at a predetermined interval, i.e., outputs the total of two sets (step S05), with the sensed results in the three directions of (0°, +20°, −20°) as one set.

Upon receiving the two sets of outputs from proximity sensor 6, determination processing unit 11 determines the movement (whether stationary or moving) of person 100 identified as an obstacle from the sensed information (step S06). Specifically, the first sensor output is compared with the second sensor output, and determination is made that the obstacle is stationary when the two sets of outputs match. If they do not matched, determination is made that the obstacle is moving.

When determination is made that the obstacle is moving at step S06, determination processing unit 11 obtains the movement vector of the obstacle that is the difference between the position vector of the sensed obstacle from the first sensor output and the position vector of the sensed obstacle from the second sensor output. From the obtained movement vector, the movement vector of the obstacle (corresponding to person 100) that is moving so as to be most proximate to main body 1 is determined (step S09). At this stage, determination processing unit 11 determines the possibility of collision by a calculation based on the movement vector and position information of the obstacle and the velocity vector of main body 1.

When determination is made of the possibility of collision with the obstacle, determination processing unit 11 stores the input from geomagnetic sensor 7 at that time point as the direction of travel of the obstacle in the storage unit (S10). Based on the stored information, main body 1 is withdrawn in accordance with the procedure set forth below.

Determination processing unit 11 causes main body 1 to turn by means of travel steering unit 2 such that the input of geomagnetic sensor 7 is 90° with respect to the moving direction of person 100 (step S11). This turning of step S11 corresponds to rotation A in FIG. 3.

After main body 1 has turned, determination processing unit 11 causes main body 1 to move straight ahead a predetermined distance of N cm (step S12). Accordingly, main body 1 is prevented from collision by withdrawal from person 100.

At the withdrawn position of main body 1, determination processing unit 11 waits until there is no longer any input of a sensed signal from human body sensors 5a-5d (step S13).

When person 100 has passed and there is no longer an input of a sensed signal from human body sensors 5a-5d, determination processing unit 11 causes main body 1 to turn 180° at that site by travel steering unit 2 (step S14). This turning of step S14 corresponds to rotation B in FIG. 3.

Under the rotated state of main body 1, determination processing unit 11 moves main body 1 straight forward N cm (step S15). Accordingly, main body 1 returns to the former position immediately previous to the obviation operation.

Finally, determination processing unit 11 causes main body 1 to turn at that site in the direction of the azimuth of cleaning stored at step S02. This turning corresponds to rotation C in FIG. 3. Following this turning, determination processing unit 11 drives the cleaning unit and travel steering unit to resume the cleaning job (step S16).

In accordance with the first embodiment of the present invention, collision with a moving obstacle can be avoided and the cleaning job can be resumed by returning to the former position after the obviation operation. Thus, safety of the main body is ensured and high job efficiency can be maintained.

### Second Embodiment

Means for avoiding collision with an obstacle was described in the previous embodiment. Since the cleaning job can be resumed after the obviation operation, higher job efficiency can be realized as compared to the conventional self-running cleaner that stops upon sensing an obstacle.

The second embodiment of the present invention is directed to another means for avoiding collision from the standpoint of efficiency of the cleaning job. The configuration of the self-running cleaner of the second embodiment is similar to that described with reference to FIGS. 1A, 1B and FIG. 2. Therefore, detailed description thereof will not be illustrated and described.

FIG. 5 is a flow chart of a collision obviation operation carried out by the self-running cleaner of the second embodiment.

Referring to FIG. 5, it is assumed that main body 1 attains a normal operation state, and executes a cleaning job while self-propelling (step S20).

At this stage, determination processing unit 11 of main body 1 constantly monitors any input from human body sensors 5a-5d to determine whether a human body has been detected or not based on the presence of an input sensed signal (step S21).

When determination is made of the presence of a human being at step S21, determination processing unit 11 provides a display message on display panel 9 to warn of the possibility of collision towards the person. Alternatively, determination processing unit 11 outputs a warning sound from speaker 10. By such warning, the moving obstacle, if a human being, can take an action to avoid collision with main body 1. Specifically, the human body may stop at that site, or alter his/her course in a direction that will avoid collision. Further alternatively, the person, if crossing the course of main body 1 ahead, can increases his/her moving speed to pass by more quickly. At this stage, determination processing unit 11 instructs travel steering unit 2 to reduce the running speed of main body 1 while continuing the cleaning job (step S22).

Determination processing unit 11 carries out the cleaning job at a decelerated state while monitoring the output from human body sensors 5a-5d to determine presence of a human body (step S23).

When no detection is made of a human body due to the retreat of the human body at step S23, determination processing unit 11 instructs travel steering unit 2 to return to the normal operation state. When detection is still made of a person, the warning action and the deceleration running of step S22 are continued. The operations of steps S22 and S23 are repeated until there is no detection of a person.

When there is a possibility of collision with an obstacle identified as a human being in accordance with the second embodiment of the present invention, a warning is issued under a decelerated state to cause the human being to retreat from the pathway of the main body. Therefore, the cleaning job can be executed without interruption. Thus, higher job efficiency can be realized as compared to the conventional self-running cleaner that stops or takes a detour upon detection of an obstacle.

Although the present invention has been described and illustrated in detail, it is clearly understood that the same is by way of illustration and example only and is not to be taken by way of limitation, the spirit and scope of the present invention being limited only by the terms of the appended claims.

1. A self-running cleaner comprising:
a cleaning unit cleaning a floor,
a travel steering unit for self-propelling of a main body,
a position identify unit identifying an azimuth of cleaning of said main body,
an obstacle sensing unit sensing presence of an obstacle, and
a determination processing unit controlling said cleaning unit and said travel steering unit in accordance with an input from said position identify unit and said obstacle sensing unit,
wherein said obstacle sensing means senses said obstacle and outputs an activated sensed signal,
wherein said determination processing unit comprises
a moving/stationary determination unit determining whether said obstacle is moving/stationary in response to activation of said sensed signal, and
a storage unit storing the azimuth of cleaning corresponding to a sensed time point of said obstacle and a moving direction of said obstacle,
in response to determination that said obstacle is moving by said moving/stationary determination unit, said travel steering unit rotates and moves said main body straight ahead a predetermined distance to withdraw said main body from said obstacle such that a direction of travel of said main body is orthogonal to the moving direction of the obstacle. and in response to inactivation of said sensed signal after the withdrawal, said main body has the direction of travel rotated 180° and moved straight ahead said predetermined distance to return to a former position where said obstacle was sensed, and said cleaning unit and said travel steering unit are driven after said main body has the direction of travel rotated back to the azimuth of cleaning corresponding to said sensed time point.

2. A self-running cleaner comprising:
a cleaning unit cleaning a floor,
a travel steering unit for self-propelling of a main body,
a position identify unit identifying an azimuth of cleaning of said main body,
an obstacle sensing unit sensing presence of an obstacle, and
a determination processing unit controlling said cleaning unit and said travel steering unit in accordance with an input from said position identify unit and said obstacle sensing unit,
wherein said obstacle sensing unit senses said obstacle and outputs a sensed signal,
wherein said determination processing unit comprises
a moving/stationary determination unit determining whether said obstacle is moving/stationary in response to activation of said sensed signal,
withdrawal means for withdrawing said main unit from said obstacle with a direction perpendicular to the moving direction of said obstacle as a direction of travel in response to determination that said obstacle is moving by said moving/stationary determination unit, and
recovery means responsive to inactivation of said sensed signal after withdrawal for returning said main body back to a former position where said obstacle was sensed, and executing a cleaning job with the azimuth of cleaning corresponding to a sensed time point of said obstacle as the direction of travel.

3. The self-running cleaner according to claim 2, wherein said determination processing unit further comprises a storage unit storing the azimuth of cleaning corresponding to the sensed time point of said obstacle and the moving direction of said obstacle.

4. The self-running cleaner according to claim 3, wherein
said obstacle sensing unit responds to activation of said sensed signal to detect twice a position of said obstacle at an interval of a predetermined term to output first and second detection result signals,
said moving/stationary determination unit determines whether said obstacle is moving/stationary based on said first and second detection result signals to detect the moving direction of said obstacle.

5. The self-running cleaner according to claim 4, wherein
said withdrawal means comprises means for rotating and moving said main body straight ahead a predetermined distance by said travel steering unit such that the direction of travel of said main body is orthogonal to the moving direction of said obstacle, and
said recovery means comprises means being responsive to inactivation of said sensed signal for turning the direction of travel of said main body 180° and moving said main body straight ahead said predetermined distance to return to a former position where said obstacle was sensed, and means for driving said cleaning unit and said travel steering unit after the direction of travel of said main body is turned to the azimuth of cleaning corresponding to said sensed time point.

6. A self-running cleaner comprising:
a cleaning unit cleaning a floor,
a travel steering unit for self-propelling of a main body,
a position identify unit identifying an azimuth of cleaning of said main body,
an obstacle sensing unit sensing presence of an obstacle,
a determination processing unit controlling said cleaning unit and said travel steering unit in accordance with an input from said position identify unit and said obstacle sensing unit, and
a notify unit indicating a state of said main body by an audio or visual signal, wherein
said obstacle sensing unit senses said obstacle to output a sensed signal, and
said determination processing unit responds to input of said sensed signal to reduce a running speed of said main body through said travel steering unit, and outputs an audio or visual signal towards said obstacle from said notify unit.
